(19) United States
(12) Patent Application Publication
(10) Pub. No.: US 2024/0185330 A1
(43) Pub. Date: Jun. 6, 2024

(54) METHOD FOR SECURING RENTAL OF A VEHICLE AND/OR PROTECTIVE EQUIPMENT FOR A VEHICLE USER

(71) Applicant: Mohamed Ait El Hadj, Nice (FR)

(72) Inventor: Mohamed Ait El Hadj, Nice (FR)

(21) Appl. No.: 17/773,479

(22) PCT Filed: Oct. 14, 2020
(86) PCT No.: PCT/EP2020/078854

§ 371 Date: Apr. 29, 2022

(30) Foreign Application Priority Data
Oct. 31, 2019 (FR) 1912248

(51) Int. Cl. G06Q 30/0645; G06Q 10/02; G06Q 50/40

(52) U.S. Cl. CPC G06Q 30/0645; G06Q 10/02; G06Q 50/40

(57) ABSTRACT

The present invention relates to a method for securing (100) rental of a vehicle and/or protective equipment for the user of the vehicle which are provided with a processor. The processor includes a central processing unit and a rewritable memory. The securing method (100) includes a step of uploading (101) connection data (200) to the processor when payment for the rental (300) is made. The connection data (200) includes a microprogram (210) that is required for operating the vehicle and/or the protective equipment for the user of the vehicle. The microprogram (210) is stored in the rewriteable memory of the processor. The method also includes a step of deleting (102) the microprogram (210) from the connection data (200) on the processor when a delete order (400) is given to the processor.

The present invention relates to a method for securing rental of a vehicle and/or protective equipment for a vehicle user.

It is common to rent a vehicle in order to carry a journey. The vehicle may be a land transport vehicle, such as a cycle or a motorcycle, for example a bicycle, a scooter, a quad bike or the like, or else an air or river transport vehicle.

In the frequent case where the vehicle is a scooter, it is recommended, or even compulsory, to use one or more pieces of protective safety equipment which are intended to protect the user in the event of a fall or accident or to improve the visibility of this user. The protective or visibility equipment is, for example, a helmet, an elbow pad, a knee pad, or a signalling device comprising one or more signalling lights or the like.

A general problem in the field resides in the fact that when the user rents such a vehicle in a self-service manner, the vehicle has no protective equipment. If the user does not possess this protective equipment, he takes a risk by using the vehicle, which it is preferable to avoid.

Rental shops for such protective equipment are known, which rent this protective equipment on request but the availability of the protective equipment is not guaranteed and the state of cleanliness of the equipment is not always optimised.

One aim of the present invention is to provide a method for securing rental of a vehicle and/or protective equipment for a user of the vehicle.

A method of the present invention is a method for securing rental of a vehicle and/or protective equipment for a user of the vehicle which are equipped with a processor. Said processor comprises a central processing unit and a rewritable memory.

According to the invention, the securing method comprises a step of uploading connection data to the processor when payment for the rental is made. Said connection data comprise a microprogram that is required for operating the vehicle and/or the protective equipment for said user. The microprogram is recorded in said rewritable memory of the processor. The method also comprises a step of deleting the microprogram from the connection data on the processor when a delete order is given to the processor.

The method advantageously comprises any one at least of the following technical features taken alone or in combination:
the connection data further comprise a piece of information relating to a rental duration of the vehicle and/or of the protective equipment of said user, and the delete order is given when a duration of use exceeds the rental duration indicated by this piece of information,
the delete order is given at the time of return of the vehicle and/or of the protective equipment of said user,
the vehicle and/or the protective equipment are stored inside a locker arranged inside a cabinet, the locker being provided with a connection cable provided with a connection plug capable of being connected to a connection port comprised by the vehicle and/or the protective equipment of said user,
the step of deleting the connection data causes a deflation of the protective equipment,
the step of deleting the connection causes a deactivation of the signalling lights of the protective equipment,
the cabinet is equipped with a compartment for inflating the protective equipment which is provided with a compressor,
the cabinet is equipped with a device for cleaning the protective equipment comprising a reserve of a disinfectant and a delivery member of the disinfectant,
the cabinet is equipped with an interactive terminal including a payment terminal for carrying out the rental of the vehicle and/or of the protective equipment of said user,
the cabinet is equipped with a monitoring device which comprises at least one camera.

The invention will be better understood on reading the non-limiting description which follows, drafted with reference to the attached drawings, in which:

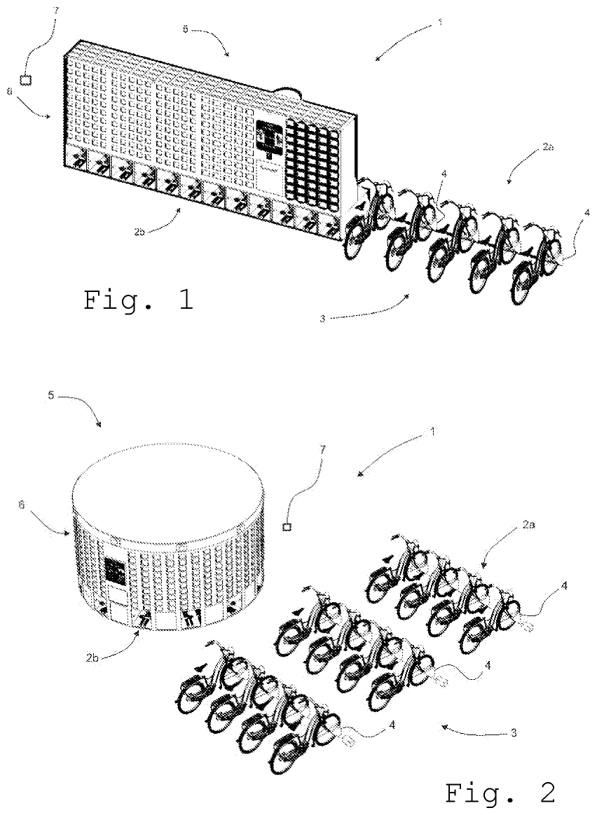

FIG. 1 schematically represents a first alternative of a vehicle rental station of the present invention;

FIG. 2 schematically represents a second alternative of a vehicle rental station of the present invention;

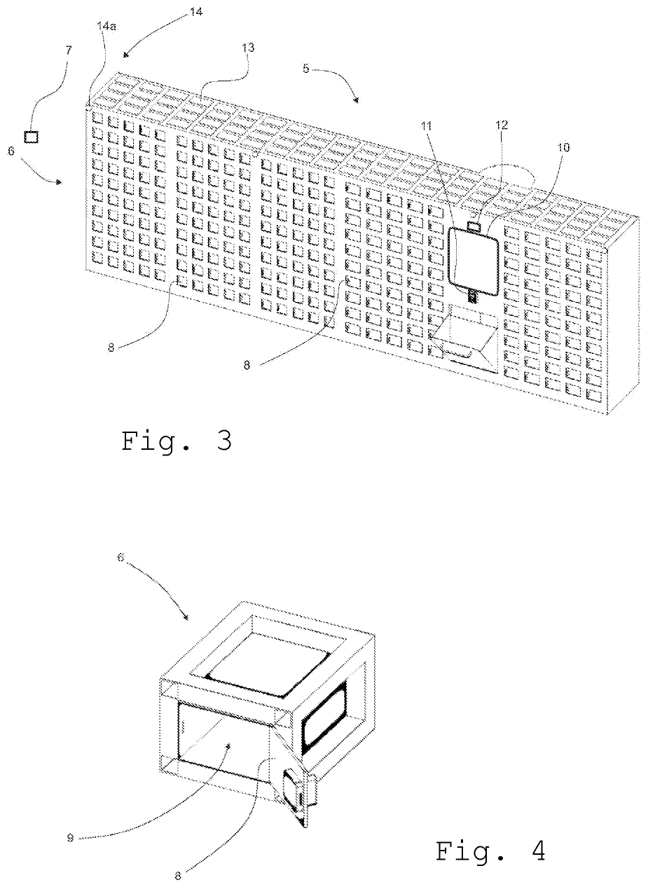

FIG. 3 schematically represents a constituent cabinet of the rental station illustrated in FIG. 1;

FIG. 4 schematically represents a constituent locker of the cabinet illustrated in FIG. 3;

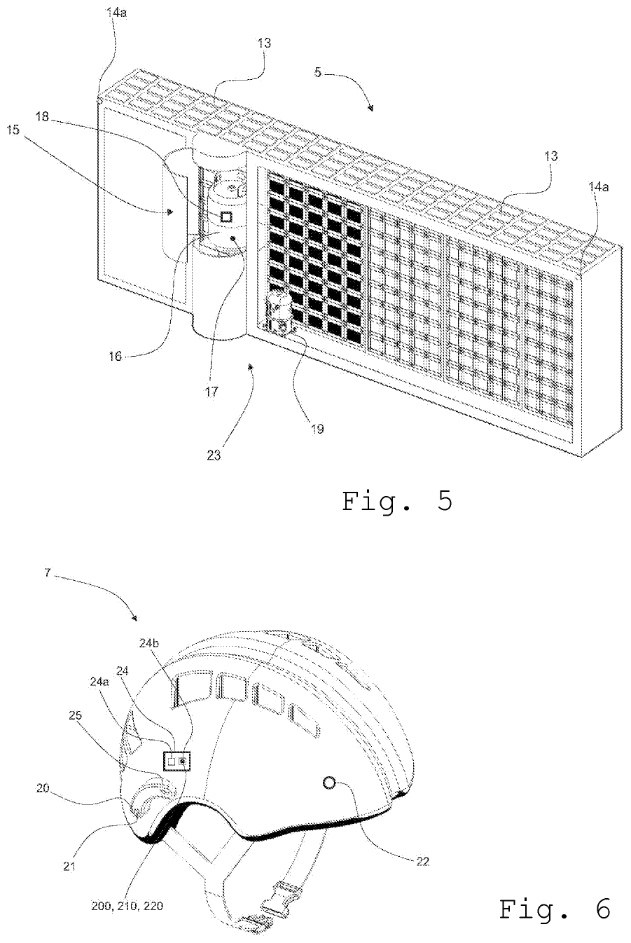

FIG. 5 schematically represents the cabinet illustrated in FIG. 3;

FIG. 6 schematically represents a protective equipment housed by the cabinet illustrated in FIGS. 3 and 5;

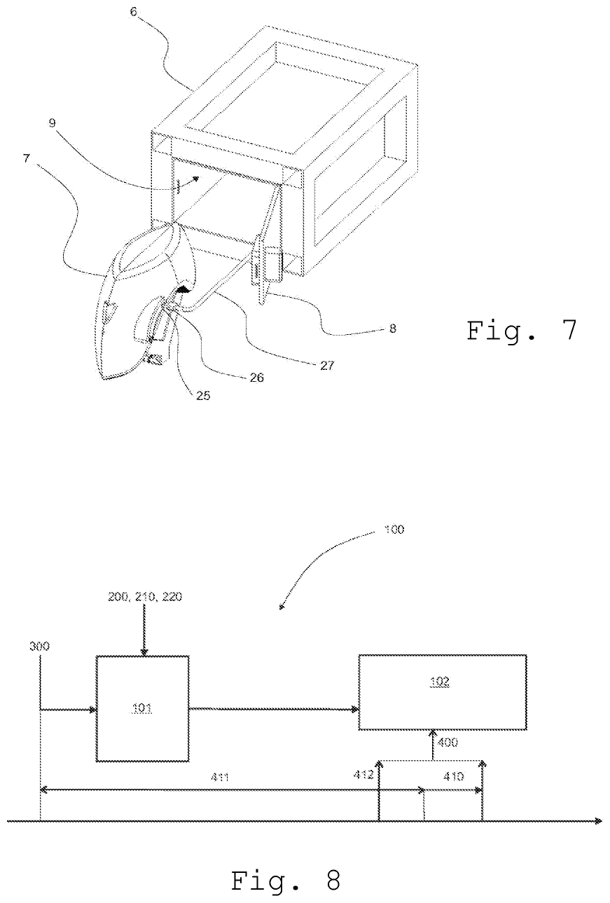

FIG. 7 schematically represents the locker illustrated in FIG. 4 and a protective equipment illustrated in FIG. 6; and

FIG. 8 schematically represents a method for securing a rental of a protective equipment illustrated in FIG. 6.

FIGS. 1 and 2 illustrate two respective alternatives of a rental station 1 for a vehicle 2a, 2b. The rental station 1 is a place where it is possible for a user to rent, for a certain rental duration, at least one vehicle 2a, 2b. The vehicle 2a, 2b may be a land transport vehicle, such as a cycle or a motorcycle, for example a bicycle 2a, a scooter 2b, a quad bike or the like, or else an air or river transport vehicle. The description below relates to a land vehicle, in particular a bicycle 2a or scooter 2b, but may be easily transposed to any vehicle. The vehicle 2a, 2b is preferably provided with an electric motor in order to enable and/or reinforce its movement.

The rental station 1 comprises, for example, a bicycle garage 3 which constitutes a place for securely parking bicycles 2a. The bicycle garage 3 comprises, in particular, a plurality of brackets 4 that are intended to enclose and hold a wheel of the bicycle 2a. Each bracket 4 is, for example equipped with a device 28 for blocking/unblocking the wheel of the bicycle 2a in order to release or immobilise the wheel of the bicycle 2a.

The rental station 1 also comprises, for example, a cabinet 5 containing a plurality of lockers 6. In FIG. 1, the cabinet 5 is shaped as a parallelepiped while in FIG. 2 the cabinet 5 is shaped as a cylinder.

Some of these lockers 6 are intended to house a scooter 2b. In order to facilitate the gripping and handling of the scooter 2b, a locker 6 housing a scooter is preferably a locker 6 arranged in a lower region of the cabinet 5.

The cabinet 5 also comprises lockers 6 which are intended to house a protective safety or signalling equipment 7. Such a protective equipment 7 is, for example a helmet, an elbow pad, a knee pad, a pair of gloves, a vest or the like. In the case where the protective equipment 7 is a helmet, an elbow pad or a knee pad, the protective equipment 7 is preferably inflatable in order to be less bulky when the protective equipment 7 is in the deflated state. These provisions are such that the lockers 6 have the smallest possible volume and are dimensioned to house a protective equipment 7 in the deflated state. It is understood, based on a given volume of the cabinet 5, that it is possible to store a large number of pieces of protective equipment 7 inside the cabinet 5, due to the fact that the pieces of protective equipment 7 are stored in the deflated state.

With reference to FIG. 3 which illustrates a cabinet 5 comprising only lockers 6 capable of housing protective equipment 7, each locker 6 includes a door 8 that can be locked and unlocked. In other words, and with reference also to FIG. 4, the door 8 is either in a locked position in which the door 8 prohibits access to an enclosure 9 capable of housing the protective equipment 7 or an unlocked position in which the door 8 offers access to the enclosure 9 in order to allow the user to take the protective equipment 7.

For this purpose, and referring again to FIG. 3, the cabinet 5 comprises an interactive terminal 10 which enables the user to choose the type and number of pieces of protective equipment 7 which he wishes to rent, to choose the rental duration and to proceed to the payment of the rental by means of a payment terminal 11 that is comprised by the interactive terminal 10. It is possible to pay the rental at a payment terminal 11 accepting a credit card, a subscription card or any other payment means. Once payment has been made, the doors 8 of the lockers 6 corresponding to the protective equipment 7 selected by the user are automatically unlocked in order to make said protective equipment 7 available. Further, the user can also recover, inside the enclosures 9 of the lockers 6 for which the doors 8 are unlocked, protective equipment 7 that is needed in order to ensure the users protection and signalling.

The interactive terminal 10 is connected, for example, to communication means 12 with a mobile telephone, an internet network or analogue electronic means which allow a user to reserve, beforehand and remotely, at least one vehicle 2a, 2b and/or one item of protective equipment 7 which it is desired to use. Such a reservation enables the user to be certain of getting the vehicle 2a, 2b and/or the protective equipment 7, which he has reserved beforehand. Similarly, such communication means 12 enable a user having rented protective equipment 7 to ensure the availability of at least one empty locker 6 enabling the protective equipment 7 to be returned.

Each locker 6 is preferably compulsorily closed, such that in the event of a power cut, the cabinet 5 remains inviolable and the protective equipment 7 is kept safe. Moreover, the cabinet 5 is preferably equipped with at least one solar panel 13 which is capable of recharging the battery contained by the cabinet 5 in order to make the cabinet 5 self-sufficient in energy and to allow it to operate, including during a power.

The cabinet 5 is equipped with a monitoring device 14 which comprises at least one camera 14a for monitoring the cabinet 5 against the actions of dishonest users. Moreover, such cameras 14a have a deterrent effect against such actions.

Referring to FIG. 5, the cabinet 5 is equipped with a device 15 for cleaning the protective equipment 7 before its use. Such a cleaning device 15 comprises, in particular, a reserve 16 of a disinfectant 17 and a delivery member 18 of the disinfectant 17. The delivery member 18 is intended to spray or apply the disinfectant 17 on the protective equipment 7. According to various alternative embodiments, such a cleaning action is either performed by a maintenance agent or else automatically inside the lockers 6. The disinfectant 17 is preferably a natural product that is not harmful to the user or to the environment.

The cabinet 5 is equipped with at least one compressor 19 for delivering compressed air for inflating the protective equipment 7. For this purpose, and referring to FIG. 6 which illustrates an item of protective equipment 7 consisting of a protective helmet, each item of protective equipment 7 is provided with an inflation valve 20 which can connect the protective equipment 7 to the compressor 19 in order to inflate it. The inflation valve 20 is provided with a non-return valve 21 which prevents deflation of the protective equipment 7 once it is inflated and disconnected from the compressor 19. The protective equipment 7 is also provided with a deflation plug 22, which enables a rapid evacuation of the air previously admitted to the interior of the protective equipment 7, in order to deflate it. This results in an ease and rapidity of return of the protective equipment 7, as well as simple and rapid placing inside the enclosure 9 provided for this purpose.

The compressor 19 and the cleaning device 15 are preferably placed inside a single compartment 23 of the cabinet 5 which is accessible to a user having performed and paid for a rental, as illustrated in FIG. 5.

Each vehicle 2a, 2b and each item of protective equipment 7 is equipped with a processor 24 which includes means for downloading connection data 200. More particularly, the processor 24 comprises a central processing unit 24a and a rewritable memory 24b. The rewritable memory 24b is, for example, a flash memory.

The connection data 200 comprise a microprogram 210 that is required for operating the vehicle 2a, 2b and/or the protective equipment 7 of the vehicle 2a, 2b. The connection data 200 also comprise a piece of information 220 relating to a duration of location of the vehicle 2a, 2b and/or the protective equipment 7 of the vehicle 2a, 2b. The rental duration is chosen, for example, from a range of rental durations, such as one hour, two hours, four hours, eight hours, a half-day or a day.

The microprogram 210 is a microprogram which comprises instructions, the execution of which is required for operating the vehicle 2a, 2b and/or the protective equipment 7 of the user of the vehicle 2a, 2b. For example, the microprogram 210 is the microprogram executed by the central processing unit 24a of the processor 24 of the vehicle 2a, 2b and/or the protective equipment 7 of the user of the vehicle 2a, 2b.

The protective equipment 7 and the vehicle 2a, 2b are also equipped with a connection port 25, such as a USB port or the like, which is connected to the processor 24. The connection port 25 is capable of receiving a connection plug 26 which is connected to a connection cable 27 housed inside the enclosure 9, as illustrated in FIG. 7.

The connection data 200 of the protective equipment 7 are downloaded to the processor 24 after confirmation of the rental, via the connection cable 27 housed inside the enclosure 9 and connected to the connection plug 26 inside the connection port 25. Such a download authorises a use of the protective equipment 7 during the rental duration. More particularly, such a download enables the functions of the protective equipment 7 to be implemented, such as the use of the signalling lights when the protective equipment 7 is a signalling accessory, or else the use of the inflatable nature of the protective equipment 7 when it is an inflatable accessory. In other words, such a download enables the user to inflate the protective equipment 7 and to keep this inflated during the rental duration.

At the time of the return of the protective equipment 7, the user reconnects to the connection plug 26 inside the connection port 25 which causes a deleting of the connection data 200 on the processor 24. The deletion of the connection data 200 consists, for example, of rewriting over the microprogram 210 and the previously downloaded rental duration information 220. According to a preferred embodiment, the rewriting consists of writing “1” on the entirety of the rewritable memory 24b, or at least over an area thereof used for the preceding downloads. Such a deletion makes it impossible to inflate the protective equipment 7 or else makes it impossible to operate the signalling lights.

When a time of use of the protective equipment for a user 7 by the user exceeds the rental duration, the connection data 200 are automatically deleted which also causes a deletion of the connection data 200 on the processor 24 and also causes a deflation of the accessory 7 or else makes it impossible to operate the signalling lights of the protective equipment.

With reference to FIG. 8, it is understood that a method for securing 100 a rental of the vehicle 2a, 2b and/or of the protective equipment 7 of the user of the vehicle 2a, 2b comprises a step of uploading 101 connection data 200 to the processor 24 when a payment of the rental 300 is made. More particularly, the rewritable memory 24b is configured to receive the microprogram 210 when the payment of the rental is carried out. It is understood that the downloading of the microprogram 210 into the rewritable memory 24b attests to the payment due and enables proper use of the vehicle 2a, 2b and/or of the protective equipment 7.

The method 100 for securing the rental of the vehicle 2a, 2b and/or of the protective equipment 7 of the user of the vehicle 2a, 2b also comprises a step of deleting 102 the connection data 200 on the processor 24 when a delete order 400 is given to the processor 24. More particularly, the deletion step 102 is a step during which the microprogram 210 is deleted from the rewritable memory 24b. It is also understood that once the microprogram 210 is deleted from the rewritable memory 24b, the vehicle 2a, 2b and or the protective equipment 7 can no longer be appropriately used.

The delete order 400 is given, in particular, when a duration of use 410 exceeds a rental duration 411.

The delete order 400 is also given, in particular, at the time of return 412 of the vehicle 2a, 2b and/or of the protective equipment 7 of the user of the vehicle 2a, 2b.

According to an alternative, the step 102 of deleting the connection data 200 causes a deflation of the protective equipment 7. More particularly, the step 102 of deleting the microprogram 210 in the rewritable memory 24b causes a deflation of the protective equipment 7.

According to another alternative, the step of deleting 102 the a connection data 200 causes deactivation of the signalling lights of the protective equipment 7. More particularly, the step 102 of deleting the microprogram 210 in the rewritable memory 24b causes a deactivation of the signalling lights of the protective equipment 7.

1. A method for securing rental of a vehicle and/or protective equipment of the user of the vehicle, which are equipped with a processor, the processor comprising a central processing unit and a rewritable memory, wherein the method comprises: uploading connection data to the processor when payment for the rental is made, the connection data comprising a microprogram that is required for operating the vehicle and/or the protective equipment of the user of the vehicle, the microprogram being recorded in the rewritable memory of the processor, and
deleting the microprogram from the connection data on the processor when a delete order is given to the processor.

2. The method according to claim 1, wherein the connection data further comprises a piece of information relating to a rental duration of the vehicle and/or of the protective equipment of the user of the vehicle, and wherein the delete order is given when a duration of use exceeds the rental duration indicated by this the piece of information.

3. The method according to claim 1, wherein the delete order is given at the time of return of the vehicle and/or the protective equipment of the user of the vehicle.

4. The method according to claim 1, wherein the vehicle and/or the protective equipment are stored inside a locker arranged inside a cabinet, the locker being provided with a connection cable provided with a connection plug capable of being connected to a connection port comprised by the vehicle and/or the protective equipment of the user of the vehicle.

5. The method according to claim 1, wherein the deleting of the connection data causes a deflation of the accessory or prevents the inflation of the protective equipment.

6. The method according to claim 1, wherein the deleting of the connection data causes a deactivation of the signalling lights of the accessory.

7. The method according to claim 4, wherein the cabinet is equipped with a compartment for inflating the protective equipment which is provided with a compressor.

8. The method according to claim 4, wherein the cabinet is equipped with a device for cleaning the protective equipment comprising a reserve of a disinfectant and a member for delivering the disinfectant.

9. The method according to claim 4, wherein the cabinet is equipped with an interactive terminal including a payment terminal for carrying out the rental of the vehicle and/or of the protective equipment of the user of the vehicle.

10. The method according to claim 4, wherein the cabinet is equipped with a monitoring device which comprises at least one camera.

11. The method according to claim 2, wherein the delete order is given at the time of return of the vehicle and/or the protective equipment of the user of the vehicle.

12. The method according to claim 2, wherein the vehicle and/or the protective equipment are stored inside a locker arranged inside a cabinet, the locker being provided with a connection cable provided with a connection plug capable of being connected to a connection port comprised by the vehicle and/or the protective equipment of the user of the vehicle.

13. The method according to claim 3, wherein the vehicle and/or the protective equipment are stored inside a locker arranged inside a cabinet, the locker being provided with a connection cable provided with a connection plug capable of being connected to a connection port comprised by the vehicle and/or the protective equipment of the user of the vehicle.

14. The method according to claim 2, wherein the deleting of the connection data causes a deflation of the accessory or prevents the inflation of the protective equipment.

15. The method according to claim 3, wherein the deleting of the connection data causes a deflation of the accessory or prevents the inflation of the protective equipment.

16. The method according to claim 4, wherein the deleting of the connection data causes a deflation of the accessory or prevents the inflation of the protective equipment.

17. The method according to claim 2, wherein the deleting of the connection data causes a deactivation of the signalling lights of the accessory.

18. The method according to claim 3, wherein the deleting of the connection data causes a deactivation of the signalling lights of the accessory.

19. The method according to claim 4, wherein the deleting of the connection data causes a deactivation of the signalling lights of the accessory.

20. The method according to claim 5, wherein the deleting of the connection data causes a deactivation of the signalling lights of the accessory.
